(19) United States
(12) Patent Application Publication
(10) Pub. No.: US 2015/0337740 A1
(43) Pub. Date: Nov. 26, 2015

(54) RAMP RATE CONTROL FOR A GAS TURBINE

(71) Applicant: Wellhead Electric Company, Inc., Sacramento, CA (US)

(72) Inventors: Christian Skov Heiberger, Fresno, CA (US); John Grant McDaniel, Sacramento, CA (US)

(21) Appl. No.: 14/717,925

(22) Filed: May 20, 2015

Related U.S. Application Data
(60) Provisional application No. 62/000,814, filed on May 20, 2014.

(51) Int. Cl. F02C 9/32; G05B 15/02

(52) U.S. Cl. CPC F02C 9/32; G05B 15/02

(57) ABSTRACT

A method for controlling a ramp rate of a gas turbine is disclosed. The method can include receiving, at a controller, a new load set-point command. An energy product of the new load set-point command is determined. Further, a ramp rate time of the gas turbine associated with the determined energy product can be determined. The method includes determining a ramp rate and ramping the gas turbine at the determined ramp rate to the new load set-point. In an example, the method includes determining a slowest ramp rate capable of achieving the new load set-point according to a market factor.

### CROSS REFERENCE TO RELATED APPLICATIONS

The present application claims priority to U.S. Provisional Patent Application Ser. No. 62/000,814 filed May 20, 2014, entitled “RAMP RATE CONTROL METHOD,” which is hereby incorporated by reference in its entirety.

### TECHNICAL FIELD

This present disclosure relates generally to energy facilities and, in particular, to methods of control for controlling the ramp rate of the gas turbine.

### BACKGROUND

Energy facilities are designed to provide energy to an electric grid in a reliable manner. Examples of energy facilities can include a gas fired generation system, such as a gas turbine generator (GTG) and a combined cycle gas turbine (CCGT). The energy facilities are configured to provide energy to the electric grid while maintaining the frequency and voltage of the electric grid within acceptable limits, such as limits set by a government body, a regulatory body, transmission grid operations, or an energy facility. Electric grid demands change depending on a number of factors including weather, market demands, and other reliability driven events. The energy facility is typically designed to ramp up, including starting, or ramp down in response to these factors.

Typical energy facilities produce power at a variety of levels based on the electric grid demands, during operation of a power producing unit, such as a gas turbine, requests are made to alter the power output, including decreasing or increasing the power output. In the instance of a new load set-point to increase the power output, the gas turbine is ramped up to the higher power output request

### SUMMARY

The present inventors have recognized, among other things, that a problem to be solved can include reducing wear on a gas turbine during a ramping operation, such as to a new load set-point of the gas turbine. Current energy facilities and gas turbines are configured to move to the new load set-point at pre-determined rate. Typically, the pre-determined rate of current gas turbines is a fast ramp rate, such as a maximum ramping capability of the gas turbine. Fast ramping of the gas turbine accelerates gas turbine wear caused by an increase temperature change rate and pressure fluctuations within the gas turbine.

The present inventors have recognized, among other things, that a problem to be solved can include ramping a gas turbine to a new load set-point so as to meet market demands while minimizing wear on the gas turbine. The new load set-point can be a result of a number of different market demands, each of which has a unique energy product response time demand. For example, a new load set-point request in response to arrest a system transient has an immediate response time demand. A new load set-point in response to economic factors has a low priority response time demand. In an example, the present subject matter can provide a solution to this problem, such as by providing a method and system that correlates the new load set-point request, the energy product response time demand, and minimizes gas turbine wear in determining a ramp rate of the gas turbine.

Due to increased variations brought about by intermittent resources, such as wind and solar power generation, the electric market is increasingly seeking faster ramp rates for gas turbine power generation facilities in order to arrest system transients. As discussed herein, faster ramp rates, however, place a higher thermal stress on gas turbine components and, therefore, decrease the efficiency and service life of the gas turbine. The present method distinguishes or characterizes the transient new load set-point requests and applies one or more appropriate ramp rates during ramping such that the new load set-point can be reached using the minimum ramp rates needed to reach the new load set-point within the response request demand. Therefore, instead of ramping a gas turbine at the higher thermal stress ramp rates every time a new load set-point request is received, the methods and systems described herein can characterize the new load set-points received and apply one or more appropriate ramp rates to the gas turbine to achieve the new loads set-point within the response request demand.

Previous methods and system, only allowed for the predetermined ramp rate to be selected in response to receiving a new load set-point. For example, in previous approaches, when a gas turbine is instructed to move to a new load set-point, a controller can ramp the engine at the predetermined rate, which is commonly the maximum ramp rate, unless it must be increased or decreased to prevent stalling. Thus, the only way to modify from the predetermined rate is if stalling becomes a concern.

However, the current methods and systems of the present disclosure provide for a minimum select function for the ramp rate of a gas turbine. It is desirable in most electric markets to provide fast ramping capabilities; however, faster ramping accelerates engine wear. In order to minimize thermal stress applied to gas turbine components, but still allow for the faster response times that the market desires, the present disclosure provides a smart-ramp controller that can select the minimum ramp rate required to provide the desired service. In one example, if a change in loading is requested by an operator for the purpose of providing economic energy is required, the engine can be ramped at a slow rate. However, if the change is requested by instrumentation to arrest a system transient, then the ramp rate should be at the fasted rate allowed by a fuel valve that will not result in an engine stall. By providing a minimum select function for the ramp rate of a gas turbine, the ramp rates desired by electric markets for grid support products can be significantly increased with minimal effect to the service life of the gas turbine components.

To better illustrate the encapsulated method and systems disclosed herein, a non-limiting list of examples is provided here:

Example 1 can include subject matter (such as a method) for controlling a ramp rate of a gas turbine comprising receiving, at a controller, a new load set-point command including a new load set-point, determining an energy product corresponding to the new load set-point command, determining a ramp rate of the gas turbine associated with the determined energy product, and ramping the gas turbine at the determined ramp rate to the new load set-point.

In Example 2, the subject matter of Example 1 can optionally include receiving the new load set-point command from an operator in response to a new load set-point event.

In Example 3, the subject matter of Example 1 can optionally include where receiving the new load set-point command from a gas turbine management system configured to detect a new load set-point event.

In Example 4, the subject matter of Example 1 can optionally include a new load set-point event includes at least one of a gas turbine system transient, an energy facility transient, an environmental transient, and a grid system transient that fluctuates at least one of frequency, voltage, and power flow.

In Example 5, the subject matter of Example 1 can optionally include where the energy product is at least one of economic, non-spinning reserve, spinning reserve, regulation, and droop setting.

In Example 6, the subject matter of Example 5 can optionally include where an economic ramp rate associated with the economic energy product is at least about 15 minutes predetermined time at least partially based on a threshold pressure change rate.

In Example 7, the subject matter of Example 5 can optionally include where the non-spinning ramp rate associated with the non-spinning reserve energy product and the spinning ramp rate associated with the spinning reserve energy product is at least about 10 minutes.

In Example 8, the subject matter of Example 5 can optionally include where the regulation ramp rate associated with the regulation energy product is at least about 2 minutes.

In Example 9, the subject matter of Example 5 can optionally include where the droop ramp rate associated with the droop setting energy product is less than about 2 minutes.

In Example 10, the subject matter of Example 5 can optionally include where the droop setting energy product is associated with a new load set-point event.

In Example 11, the subject matter of Example 1 can optionally include where determining the ramp rate includes determining a slowest ramp rate capable of achieving the new load set-point according to a market factor.

In Example 12, the subject matter of Example 1 can optionally include where determining the ramp rate includes determining a non-stalling ramp rate.

In Example 13, the subject matter of Example 1 can optionally include increasing the determined ramp rate to prevent a gas turbine stall.

In Example 14, the subject matter of Example 1 can optionally include where varying the determined ramp rate as the gas turbine approaches the new load set-point.

Example 15 can include subject matter (such as a method) for controlling a ramp rate of a gas turbine comprising receiving, at a controller, a new load set-point command including a new load set-point; determining an energy product corresponding to the new load set-point command, each energy product having a corresponding response time demand; determining a ramp rate of the gas turbine associated with the determined energy product and response time demand; and incrementally ramping the gas turbine to the new load set-point including at least a first ramp rate and the determined ramp rate, the determined ramp rate greater than the first ramp rate.

In Example 16, the subject matter of Example 15 can optionally include where ramping the gas turbine to the new load set-point includes maintaining a temperature change rate below a threshold temperature change rate, if the new load set-point can be reached within the response time demand.

In Example 17, the subject matter of Example 15 can optionally include where ramping the gas turbine to the new load set-point includes maintaining a pressure change below a threshold pressure change, if the new load set-point can be reached within the response time demand.

In Example 18, the subject matter of Example 15 can optionally include where the first ramp rate is a minimum ramp rate.

Example 19 can include subject matter (such as a system) for controlling a ramp rate of a gas turbine comprising a gas turbine engine; a fuel adjuster configured to supply fuel to the gas turbine, and a controller electrically coupled to the fuel valve and the gas turbine, the controller configured to receive a command including a new load set-point for the gas turbine. The controller including a ramp rate control unit configured to determine an energy product corresponding to the new load set-point command; determine a ramp rate of the gas turbine associated with the determined energy product, and ramp the gas turbine at the determined ramp rate to the new load set-point.

In Example 20, the subject matter of Example 19 can optionally include where the ramp rate control unit is further configured to ramp the gas turbine to the new load set-point including at least a first ramp rate and the determined ramp rate, the determined ramp rate different from the first ramp rate.

Example 21 can include, or can optionally be combined with any portion or combination or any portions of any one or more of Examples 1-20 to include, subject matter that can include means for performing any one or more of the functions of Examples 1-20, or a machine-readable medium including instructions that, when performed by a machine, cause the machine to perform any one or more of the functions of Examples 1-20.

These non-limiting examples can be combined in any permutation or combination.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of a system, according to one example of the present disclosure.

FIG. 2 illustrates a flow diagram of a method of controlling a ramp rate of a gas turbine, according to one example of the present disclosure.

FIG. 3 illustrates a flow diagram of a method of controlling a ramp rate of a gas turbine, according to one example of the present disclosure.

FIG. 4 illustrates a plot of a ramp profile, according to one example of the present disclosure, according to one example of the present disclosure.

FIG. 5 illustrates a plot of a ramp profile, according to one example of the present disclosure, according to one example of the present disclosure.

FIG. 6 illustrates a plot of a ramp profile, according to one example of the present disclosure, according to one example of the present disclosure.

FIG. 7 illustrates a plot of a ramp profile, according to one example of the present disclosure, according to one example of the present disclosure.

FIG. 8 illustrates a plot of a ramp profile, according to one example of the present disclosure, according to one example of the present disclosure.

FIG. 9 illustrates a plot of a ramp profile, according to one example of the present disclosure, according to one example of the present disclosure.

### DETAILED DESCRIPTION

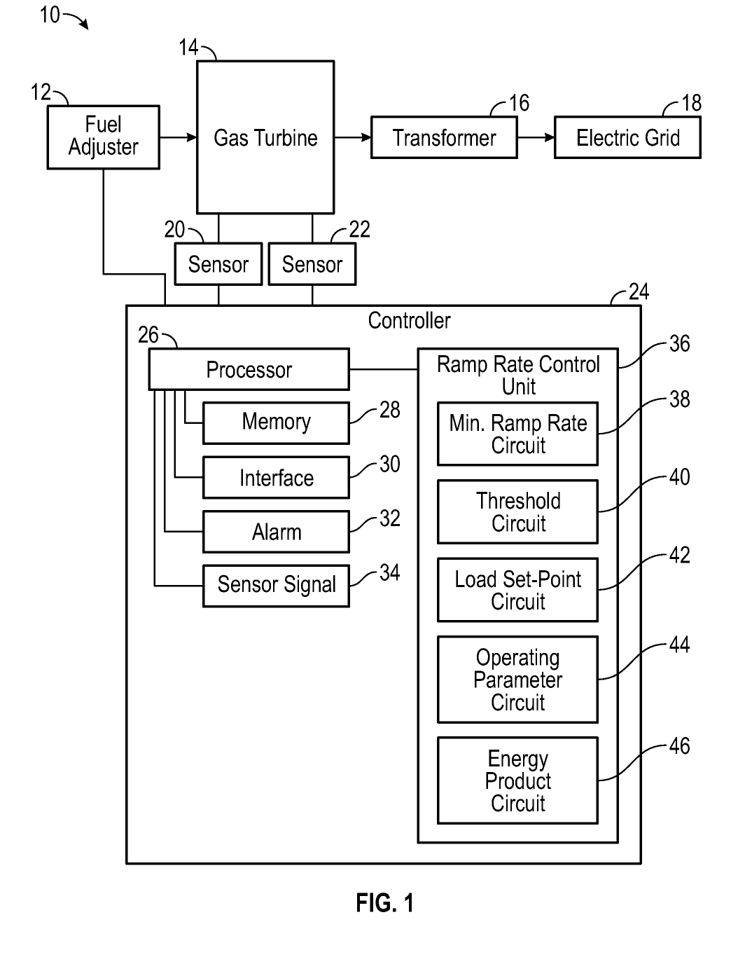

FIG. 1 illustrates an example of a block diagram of an energy system 10, according to an example of the present disclosure. The energy system 10 can include a gas turbine 14, a fuel valve 12, a transformer 16, and an electric grid 18. The energy system 10 can also include a temperature sensor 20, a pressure sensor 22, and a controller 24 for controlling the ramp rate of the gas turbine 14.

The transformer 16 can convert the output of the gas turbine 14 to a higher voltage prior to being provided to the electric grid 20. Although the energy system 10 shown in FIG. 1 shows only one gas turbine 10, examples are not so limited. The energy system 10 can include a plurality of gas turbines 14 and a plurality of fuel valves 12, where each fuel valve corresponds to one gas turbine. In an example, the energy system 10 can be located in multiple geographic locations, such that the gas turbine 12 can be separated from controller 23, for example. Thus, the footprint of the energy system 10 is not limited to a single continuous location.

The gas turbine 14 can be configured to provide a power output, including up to a full-load power output. In an example, the gas turbine 14 can include a turbine, such as an aero-derivative or heavy duty gas turbine having the full-load power output within a range from about 10 megawatts (MW) to about 250 MW or more, in some examples. In an example, the gas turbine 14 can be configured for a fast start. For example, the gas turbine 14 can be configured for a fast start within about 20 minutes or less, for example, about 10 minutes or less, about 5 minutes or less, or about 2 minutes or less.

Starting the gas turbine 14 includes changing the gas turbine 14 from the stand-by state (e.g., off-line but substantially immediately ready to start) to a desired load of the gas turbine 14, including up to the full-load power output. Off-line can include a non-power producing state of the gas turbine 14. In an example, the stand-by state of the gas turbine 14 includes the gas turbine 14 off-line, but substantially immediately ready to start. In an example, the gas turbine 14 can include an auto-start feature configured to start the gas turbine 14 in response to a frequency disturbance event. That is, in an example, the energy system 10 can provide the gas turbine 14 droop-like capability when off-line in response to a frequency disturbance event, such as a transient or decay in frequency. In an example, the gas turbine 14 can include a clutch between the gas turbine engine and the generator, so as to provide substantially synchronous condensing. Such a configuration can allow the energy system 10 to provide a substantially continuous and a substantially immediate response to electric grid transient voltage events.

As discussed herein, the electric grid 18 demands can change depending on a number of factors including weather, market demands, and other reliability driven events. When a new load set-point is received, the energy system 10 can reach the new load set-point by applying one or more ramp rates while reducing the wear on the gas turbine 14.

In an example, the energy system 10 can provide a minimum select function for the ramp rate of the gas turbine 14. For example, each new load set-point command can require a different performance. The controller 24 can determine an energy product for each new load set-point command and determine an associated ramp rate of the particular energy product. Each determined energy product can have different ramp rates. The energy system 10 of the present disclosure allows the gas turbine 14 to be ramped at an appropriate ramp rate such that the desired service can still be provided while providing the minimum ramping necessary.

As opposed to ramping the gas turbine 14 with the same ramp rate in response to each new load set-point command received, the energy system 10 of the present disclosure can determine, for example, response time demands based for each new load set-point command and apply minimum ramp rates to minimize thermal stress (e.g., temperature change rate) applied to the gas turbine 14 components, thereby maintaining the efficacy of the gas turbine 14 and extending the life of the gas turbine 14 components. Maintaining the efficiency and increasing the lifetime of the gas turbine 14 components can reduce the overall operating costs of the gas turbine 14.

The energy system 10 can include a pressure sensor 20 and a temperature sensor 22. The pressure sensor 20 can be configured to sense the current operating pressure of the gas turbine 12. The pressure sensor 20 can be electrically coupled to the controller 24 such that the pressure sensor 20 can send a signal indicating the current operating pressure to the controller 24. The temperature sensor 22 can be configured to sense the current operating temperature of the gas turbine 12. The temperature sensor 22 can be electrically coupled to the controller 24 such that the temperature sensor 22 can send a signal indicating the current operating temperature to the controller 24.

In an example, the pressure and temperature sensors 20, 22 can continuously sense and send the current operating pressure and temperature to the controller 24. In another example, the pressure and temperature sensors 20, 22 can intermittently sense and send the current operating pressure and temperature to the controller 24. For example, when the gas turbine 14 is operating at a constant load, the pressure and temperature sensors 20, 22 can sense and send the current operating pressure and temperature to the controller 24 at intervals, for example, every few minutes. However, during ramping, the pressure and temperature sensors 20, 22 can continuously sense and send the current operating pressure and temperature to the controller 24.

As discussed herein, certain temperatures change rates and pressure fluctuations within a gas turbine 14 can be damaging to components of the gas turbine 14 and reduce the efficiency and lifetime of the gas turbine 14. For example, having repeated fluctuations of pressure or having the temperature change rate during a ramp repeatedly exceed a threshold pressure change and a threshold temperature change rate, can damage components within the gas turbine 14 and decrease the efficiency and life of the gas turbine 14, as well as increase the operating costs of the gas turbine 14. When the gas turbine 14 is ramped, the pressure change can fluctuate and the temperature change rate can vary within the gas turbine 14. For example, when the initial flow rate of the fuel is changed, the pressure can spike or fluctuate and exceed a threshold pressure change. Further, depending on the ramp rate of the gas turbine, the temperature change rate can exceed a threshold temperature change rate. For example, as the ramp rate increases so does the temperature change rate.

As discussed herein, the energy system 10 characterize which new load set-points commands requires ramping at a high ramp rate and which of those do not. Therefore, the energy system 10 of the present disclosure can only use high ramp rates when necessary and minimize unnecessarily operating with a high ramp rate when the desire service can be provided without using the high ramp rate.

Threshold pressure changes can vary between different gas turbine systems. As described herein, the “threshold pressure change” is a fluctuation of pressure that occurs in a gas turbine as the ramping process begins (simultaneously with the change in fuel rate) or during ramping. Further, the energy system 10 of the present disclosure can determine when a ramp rate that can maintain the change of temperature rate during ramping below a threshold temperature change rate during ramping. The threshold temperature change rate can vary between different gas turbines, as each gas turbine 14 can handle different temperature change rates.

In an example, the threshold temperature change rate and the threshold pressure change can be dependent on the particular gas turbine 14 and how long the gas turbine 14 has been operating. For example, a newer gas turbine may be able to have a higher threshold pressure or threshold temperature as compared to an older gas turbine. In an example, the threshold pressure change can be, but is not limited to, less than 15 pounds per square inch (psi). In an example, the threshold pressure change can be, but is not limited to, less than 10 psi such as 9 psi, 8 psi, 7 psi, 6 psi, 5 psi, 4 psi, 3 psi, 2 psi, 1 psi and zero psi.

As discussed herein, certain temperature change rates (° C./time) and corresponding pressure change rates (psi/time), can be damaging to components of the gas turbine 14 and reduce the efficiency and lifetime of the gas turbine 14. For example, having temperature change rates within the gas turbine 14 during ramping that repeatedly exceed a threshold temperature change rate, can damage components within the gas turbine 14 and decrease the efficiency and life of the gas turbine 14 as well as increase the operating costs of the gas turbine 14. When the gas turbine 14 is ramped, the temperature change rate can vary depending on the ramp rate. In an example, as the ramping rate of the gas turbine 14 increases, so does the temperature change rate and corresponding pressure change rate.

The threshold temperature change rate can be a predetermined difference from a maximum temperature change rate that the gas turbine is configured to run without stalling, including any design limitations. The threshold temperature change rate can be dependent on the particular gas turbine 14 and how long the gas turbine 14 has been operating. For example, a newer gas turbine may be able to handle a higher threshold temperature change rate as compared to an older gas turbine. The energy system 10 of the present disclosure can determine with new load set-point requests can be ramped at ramp rates below the threshold temperature change rate and threshold pressure changes.

As discussed further herein, there may be instances where the gas turbine 14 needs to be ramped at a ramp rate that will increase the temperature change rate or include pressure fluctuations that extend beyond the threshold temperature change rate and the threshold pressure.

For example, certain commands for a new load set-point can have an associated response time demand. In some instances, the response time demand may not be met without ramping the gas turbine 14 at a ramping rate for a certain time period that will cause one or more pressure fluctuations and/or a change of temperature rate that exceed the threshold pressure change and the threshold temperature change rate. However, the energy system 10 of the present disclosure can distinguish when such ramp rates are necessary and limit the number of times the gas turbine 14 is ramped at a ramp rate that will produce a temperature change rate that exceeds the threshold temperature change rate or creates pressure fluctuations greater than the threshold pressure change. A ramp rate that includes either producing pressure fluctuations greater than the threshold pressure change or producing a change of temperature rate greater than the threshold temperature rate is referred to herein as a “high ramp rate.” A ramp rate the includes ramping at the maximum ramp rate is referred to herein as the “maximum ramp rate.”

By minimizing the number of times the gas turbine 14 ramps including the high or max ramp rate, the lifetime of the components of the gas turbine 14 can be extended and the efficiency of the gas turbine 14 can be increased. By increasing the lifetime of the components of the gas turbine 14, the expense for maintaining and running the gas turbine 14 can be reduced and the operating costs of the gas turbine 10 can be reduced.

The fuel adjuster 12 can adjust the flow rate of the fuel supplied to the gas turbine 14. For example, when the load of the gas turbine 14 is ramped up or ramped down, the fuel adjuster 12 can adjust the rate of fuel supplied to the gas turbine 14. Stated differently, to change the ramp rate of the gas turbine 14, the rate of fuel that is supplied to the gas turbine 14 can be changed via, for example, a fuel valve. For example, to increase the ramp rate, the rate of fuel supplied to the gas turbine 14 can be increased and to decrease the ramp rate of the gas turbine 14 the rate of fuel supplied to the gas turbine 14 can be decreased.

Throughout the disclosure, adjusting the ramp rate of the gas turbine 14 is discussed in terms of adjusting a position of a fuel adjuster 12. That is, to change the ramp rate of the gas turbine 14, a position of the fuel adjuster 12 can change thereby increasing or decreasing the amount of fuel supplied to the gas turbine 14. Each position of the fuel adjuster 12 can correspond to a ramp rate. For example, the fuel adjuster 12 can include a closed position, a maximum position, a threshold position, and a plurality of intermediate positions. In an example, changing a position of the fuel adjuster 12 can change a size of an opening (e.g., aperture) that supplies the fuel to the gas turbine 14. In the closed position, the fuel adjuster 12 can be shut (e.g., the opening that supplies the fuel to the gas turbine 14 is closed) and no fuel is supplied to the gas turbine 14. In the maximum position, the fuel adjuster 12 is at a position that corresponds to a maximum ramping rate capability of the gas turbine 14. In one example, the maximum position of the fuel adjuster 12 can correspond to the maximize size of the opening that supplies the fuel to the gas turbine 14. That is, physically the a fuel valve or fuel pump cannot be moved to any further position to increase the size of the opening that supplies fuel to the gas turbine 14 or increase the flow rate of the fuel. In another example, the maximum of the fuel adjuster 12 corresponds to the maximum ramping rate, but is not necessarily the physical limit of the fuel adjuster 12.

The maximum ramp rate capability of the gas turbine 14 is defined as megawatts per min that the gas turbine 14 can move based on the design envelope of the particular gas turbine 14 as well as preventing the gas turbine 14 from stalling. That is, gas turbines 14 may have the capability to operate at a particular ramp rate, however, that particular ramp rate may cause the gas turbine to stall. Thus, the maximum ramping rate depends on stalling conditions as well as the gas turbines design envelope.

The threshold position can be a predetermined range less than the maximum ramping rate and correspond to a threshold ramping rate The threshold ramping rate can produce a pressure fluctuation equal to or greater than the threshold pressure change and/or produce a change of temperature rate equal to or greater than the threshold temperature change rate.

The plurality of intermediate positions of the fuel valve 12 can include positions between the closed position and the maximum position, where each intermediate position corresponds to an intermediate ramping rate. The intermediate ramp rate can be a ramp rate that is known not produce a temperature rate change that exceeds the threshold temperature change rate.

In an example, the fuel adjuster 12 can include a minimum movement capability. The minimum movement capability can be a change in the position of the fuel adjuster 12 that increases the flow rate of the fuel to the gas turbine 14 a predefined amount that does not cause detrimental pressures changes (e.g., fluctuations) within the gas turbine 14. As discussed herein, when the gas turbine 14 begins the ramping process (in response to receiving a command for a new load set-point), the initial change in the flow rate of fuel can cause a pressure fluctuations, which can be detrimental to the gas turbine 14 components, as discussed herein. The minimum movement capability of the fuel valve 12 can correspond to a minimum ramp rate. The minimum ramp rate can be a ramp rate that is known not to cause the fluctuations or pulsations outside of the threshold pressure change when the flow rate of the fuel to the gas turbine 14.

As discussed herein, when a new load set-point is received for the gas turbine, previous approaches have generally ramped the gas turbine 14 at a constant pre-determined ramp rate. Generally, the pre-determined ramp rate of the previous approaches is the maximum ramp rate of the gas turbine 14 to reach the new load set-point as fast as possible, while preventing the gas turbine 14 from stalling. However, ramping at the maximum ramp rate can produce temperature change rates and potential pressure fluctuations beyond the threshold temperature change rate and the threshold pressure change.

As discussed herein, adjusting the ramp rate of the gas turbine 14 is generally discussed in terms of adjusting a position of a fuel adjuster 12 including either adjusting a position of a fuel valve or a power of a fuel pump. Therefore, adjusting or metering the fuel adjuster 12 is generally meant to include changing the flow rate of fuel supplied to the gas turbine. In an example, changing the flow rate of fuel to the gas turbine 14 can include, but is not limited to, a fuel valve being adjusted to change the size of an opening that supplies the fuel to the gas turbine 14 or changing the flow rate of the fuel via a fuel pump 12.

The energy system 10 can include the controller 24 that can be used to control the ramp rate of the gas turbine 14 including, but not limited to, ramping the gas turbine 14 when a new load set-point is received. The controller 24 can be electrically coupled to at least one of the fuel adjuster 12, the pressure sensor 20, and the temperature sensor 22. The controller 24 can include a memory 28, an interface 30, an alarm 32, a sensor signal circuit 34, and a ramp rate control unit 36. The controller 24 can form or be part of one or more computers. As illustrated in the example, the memory 28, the interface 30, the alarm 32, the sensor signal circuit 34, and the ramp rate control unit 36 are in communication with the processor 26. The processor 26 be configured to execute instructions to operate, including ramping, the gas turbine 14.

In an example, the signal sensor circuit 34 can receive a signal indicating a command for a new load set-point for the gas turbine 14. In an example, the command can be received from the operator or a gas turbine management system in response to a new load set-point event. In an example, the new load set-point event includes an event that fluctuates at least one of frequency, voltage, or power flow. A new load set-point event includes, but is not limited to, a gas turbine system transient, an energy facility transient, an environmental transient, and a grid system transient, and an economic transient.

In an example, the signal sensor circuit 34 can also receive signals from the fuel adjuster 12 and the sensors 20, 22. The signals received from the sensors 20, 22 can include the operating temperature and the operating pressure of the gas turbine 14. The signal received from the fuel adjuster 12 can include a fuel valve position and/or a fuel pump flow rate.

Overtime, the memory 28 can be updated with the most current initial pressure fluctuations and temperature change rates, associated with various operating parameters including, but not limited to, the ramp rate, the fuel used, and the air-fuel ratio. As discussed herein, the memory 28 can be accessed by the ramp rate control unit 36 when determining various ramp rates for the gas turbine 14. The memory 28 can also be used to save the ramp profiles (including the ramp rates and pressure and temperature change profiles and pressure and temperature change rate profiles for various ramp sessions). These ramp profiles can be accessed later for use later by technicians.

The interface 30 can include a keyboard, a touchpad, a screen, a printer, a network interface, or other component configured to allow a user to view and monitor the ramp profiles. In one example, the ramp profiles can be plotted and displayed to a user via the interface 30. The alarm 32 can be signaled for various reasons. For example, if the pressure, temperature, pressure change rate, or temperature change rate is within a predetermined range from the threshold temperature, threshold pressure, threshold temperature change rate, and threshold pressure change rate, the alarm 32 can be signaled to alert a technician.

The ramp rate control unit 36 can be used to determine a ramp rate associated with the new load set-point command. The ramp rate control unit 36 can determine a ramp rate of the gas turbine 14 associated with the determined energy product and ramping the gas turbine 14 at the determined ramp rate to the new load set-point. The ramp rate control unit 36 can include a minimum ramp rate circuit 38, a threshold circuit 40, a load set-point circuit 42, and an operating parameter circuit 44.

In an example, in response to receiving a new load set-point the minimum ramp rate circuit 38 can communicate with the threshold circuit 40, the load set-point circuit 42, and the operating parameter circuit 44 to determine if the gas turbine 14 can be ramped using one or more ramp rates that maintain the temperature change rate below the threshold temperature change rate and reach the new load set-point within the response time demand. In response to determining whether ramp rates below the threshold ramp rates can be used, the minimum ramp rate circuit 38 can determine one or more ramp rates to ramp the gas turbine to the new load set point.

In another example, the minimum ramp rate circuit 38 can determine whether or not the one or more ramp rates can be used to also maintain any fluctuations of pressure within the threshold pressure change and still meet the new load set-point within the response time demand.

Once one or more ramp rates are determined by the minimum ramp rate circuit 38, the minimum ramp rate circuit 38 can send a signal to the fuel adjuster 12 to meter, for example, a fuel valve or fuel pump to a first position that corresponds to the determined ramp rate

The operating parameters circuit 44 can receive signals indicating the current load of the gas turbine 14 and the current temperature, pressure, temperature change rate, and pressure change rate of the gas turbine 14. In an example, the operating parameter circuit 44 can receive signals indicating the type of fuel being used and the current air-fuel ration for use by the ramp rate circuit 38 in determining ramp rates while ramping a gas turbine 14 to a new load set-point.

The load set-point circuit 42 can receive the new load-set point command and determine the energy product of the new load-set point command. In an example, the load set-point circuit 42 can determine the energy product by factoring a number of elements, including at least one of, the source from which the new load set-point was received, such as the operator or the energy facility management system, the load set-point event, and the time of day. Energy products include, but are not limited to, economic, non-spinning reserve, spinning reserve, regulation, and droop setting. The economic energy product includes a new load set-point that, for substantially economic reasons, which includes supply and demand commodity pricing in real time (e.g., 5 minute pricing), but may include premiums for ramping speed, instructs the gas turbine to ramp to the new load set-point. The non-spinning reserve and spinning reserve energy product s include new load set points that are targeting powering ancillary services, such as spinning reserves, non-spinning reserves, and regulation reserves, and additional functions of the energy facility. In an example, the economic energy product, non-spinning reserve, and spinning reserve energy product s are associated with a new load set-point command received from at least one of the operator and the energy facility management system. The regulation energy product includes the new load-set point substantially associated with meeting regulations, such as local or federal government regulations, including environmental, output requirements, or the like. The droop setting energy product is associated with a frequency change. For example, the grid system transient includes variations brought about by intermittent resources, such as wind and solar power generation.

Based on the energy product the load set-point circuit 42 can communicate to determine a ramp rate time of the gas turbine associated with the determined energy product. The determined ramp rate time is the time it takes the gas turbine, at the current load set-point, to achieve the new load set-point. The determined ramp rate time, in various examples, is from about 2 seconds to about 20 minutes or more. In an example, the ramp rate time associated with the economic energy product is at least about 15 minutes. The economic energy product is for non-reliability operations. As such, the ramp rate time associated with the economic energy product can be generally slower than other energy products required for reliability reasons. In an example, the ramp rate time associated with the economic energy product is a slowest ramp rate capable for the gas turbine while still meeting the market intervals required for economic energy. In an example, the associated ramp rate time with the non-spinning reserve energy product and the spinning reserve energy product is at least about 10 minutes. In an example, the associated ramp rate time with the regulation energy product is at least about 2 minutes. The associated ramp rate time with the droop setting energy product is less than about 2 minutes. That is, the ramp rate time associated with the droop setting, in an example, is as fast as the gas turbine can safely ramp to the new load set-point.

The threshold circuit 40 can access the memory 28 to determine the threshold temperature rate change and threshold pressure change associated with various ramp rates. The minimum ramp rate circuit 38 can communicate with the threshold circuit 40, the load set-point circuit 42, and the operating parameter circuit 44 to determine a ramp rate for the gas turbine 14 to reach the new load set-point. For example, the minimum ramp rate circuit 38, can determine if the new load set-point can be reached by using one or more ramp rates that produce a pressure fluctuation and temperature change rate that are below the threshold pressure change and the threshold temperature change rate. If so, the minimum ramp rate circuit 38 determines the lowest ramp rate that can be used such that the new load set-point can be reached within the ramp rate time corresponding to the energy product received with the new load set-point command.

In various examples, for every determined energy product that is not the droop setting, the associated ramp rate time includes ramping at the slowest ramp rate capable of achieving the new load set-point according to a market factor. Market factors include, but are not limited to, grid demands for energy, reliability reserves, and responses to system transients.

In an example, the ramp rate can be determined by the threshold temperature change rate and the threshold pressure change. That is, the determined ramp rate is the ramp rate at which the gas turbine can ramp without exceeding at least one of the threshold temperature change rate and the threshold pressure change. Such examples can provide the benefit of reducing wear and stress on gas turbine components caused by elevated temperature change rates and pressure fluctuations. The threshold temperature change rate and the threshold pressure change can be unique for each energy product. For example, the threshold temperature change rate for the droop setting energy product can be greater than the threshold temperature change rate for the economic energy product temperature threshold. A greater threshold temperature change rate and threshold pressure change can allow for a quicker ramp rate of the gas turbine.

In some examples, the energy system 10 of the present disclosure provides a ramping the gas turbine 14 to a new load set-point using at least two different ramp rates, where one ramp rate is the determined ramp rate and the other ramp rates are less than the determined ramp rate. During the ramping, the load set-point circuit 42 can be used to determine how much more the gas turbine needs to be ramped to reach the new load set-point and adjust the ramp rates accordingly such that the new load set-point is reached with the ramp rate time (also described herein as a response request demand.

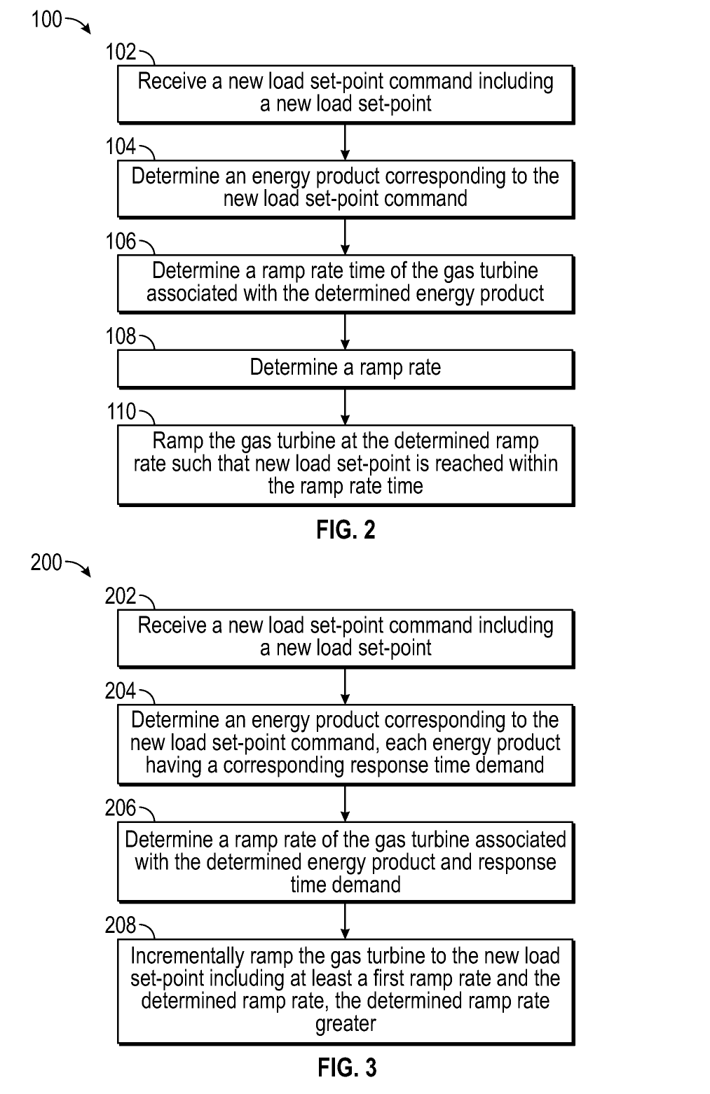

FIG. 2 illustrates a flow diagram of a method 100 for controlling a ramp rate of a gas turbine. At 102, the method 100 can include includes receiving, at a controller, a new load set-point command. A new load set-point can include a power output, such as in megawatts, of a gas turbine. In the present disclosure examples are directed generally toward a new load set-point that is greater than a current running state of the gas turbine, however the present disclosure is not so limited. For example, the method 100 includes, prior to receiving the new load set-point command, operating the gas turbine at a current load set-point, wherein the current load set-point is lower than the new set-point. As discussed herein, the new load set-point is received from at least one of an operator or a management system, such as a gas turbine management system or an energy facility management system.

In an example, the new load set-point command is received from the operator or the gas turbine management system in response to a new load set-point event. The new load set-point event includes an event that fluctuates at least one of frequency, voltage, or power flow. A new load set-point event includes, but is not limited to, a gas turbine system transient, an energy facility transient, an environmental transient, and a grid system transient.

At 102, the method 101 includes determining an energy product of the new load set-point command. In an example, determining the energy product includes factoring a number of elements, including at least one of, the source from which the new load set-point was received, such as the operator or the energy facility management system, the load set-point event, and the time of day. Energy products include, but are not limited to, economic, non-spinning reserve, spinning reserve, regulation, and droop setting. The economic energy product includes a new load set-point that, for substantially economic reasons, instructs the gas turbine to ramp to the new load set-point. The non-spinning reserve and spinning reserve energy products include new load set points that are targeting powering ancillary services, such as additional functions of the energy facility. In an example, the economic energy product, non-spinning reserve, and spinning reserve energy product s are associated with the new load set-point command received from at least one of the operator and the energy facility management system. The regulation energy product includes the new load-set point substantially associated with meeting regulations, such as local or federal government regulations, including environmental, output requirements, or the like. The droop setting energy product is associated with a frequency change. For example, the grid system transient includes variations brought about by intermittent resources, such as wind and solar power generation.

At 106, the method 10 includes determining a ramp rate time of the gas turbine associated with the determined energy product. The determined ramp rate time is the time it takes the gas turbine, at the current load set-point, to achieve the new load set-point. The determined ramp rate, in various examples, is from about 2 seconds to about 20 minutes or more. In an example, the ramp rate time associated with the economic energy product is at least about 15 minutes. The economic energy product is for non-reliability operations. As such, the ramp rate associated with the economic energy product is generally slower than other energy products required for reliability reasons. In an example, the ramp rate time associated with the economic energy product is a slowest ramp rate capable for the gas turbine while still meeting the market intervals required for economic energy.

In an example, the associated ramp rate times with the non-spinning reserve energy product and the spinning reserve energy product is at least about 10 minutes. In an example, the associated ramp rate times with the regulation energy product is at least about 2 minutes. The associated ramp rate times with the droop setting energy product is less than about 2 minutes. That is, the ramp rate times associated with the droop setting, in an example, is as fast as the gas turbine can safely ramp to the new load set-point.

In various examples, for every determined energy product that is not the droop setting, the associated ramp rate is the slowest ramp rate capable of achieving the new load set-point according to a market factor. Market factors include, but are not limited to, grid demands for energy, reliability reserves, and responses to system transients.

At 108, method 100 can include determining a ramp rate. As discussed herein, the ramp rate can be determined by the threshold temperature change rate and the threshold pressure change. That is, the determined ramp rate is the ramp rate at which the gas turbine can ramp without exceeding at least one of the threshold temperature change rate and the threshold pressure change. Such examples can provide the benefit of reducing wear and stress on gas turbine components caused by elevated temperature change rates and pressure fluctuations. The threshold temperature change rate and the threshold pressure change can be unique for each energy product. For example, the threshold temperature change rate for the droop setting energy product can be greater than the threshold temperature change rate for the economic energy product temperature threshold. A greater threshold temperature change rate and threshold pressure change can allow for a quicker ramp rate of the gas turbine.

FIG. 3 illustrates a method 200 for controlling the ramp rate of a gas turbine. At 202, the method 200 can include receiving, at a controller, a new load set-point command including a new load set-point, as discussed herein. At 204, the method 200 can include determining an energy product corresponding to the new load set-point command, each energy product having a corresponding response time demand, as discussed herein. At 206, the method 200 can include determining a ramp rate of the gas turbine associated with the determined energy product and response time demand, as discussed herein. At 208, the method 200 can include incrementally ramping the gas turbine to the new load set-point including at least a first ramp rate and the determined ramp rate, the determined ramp rate greater than the first ramp rate.

In an example, if the new load set-point can be reached within the response time demand, ramping the gas turbine to the new load set-point can include maintaining a temperature change rate below a threshold temperature change rate. In an example, if the new load set-point can be reached within the response time demand, ramping the gas turbine to the new load set-point can include maintaining a pressure change below a threshold pressure change.

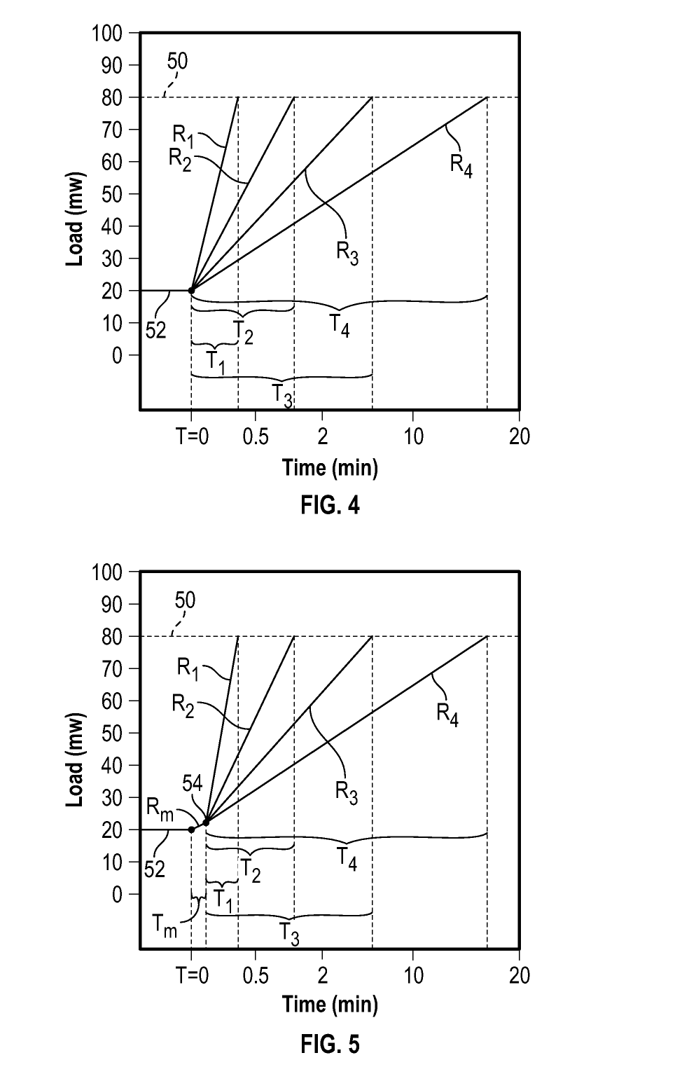

FIGS. 4-9 illustrate plots of an example ramp profile. The values represented in FIGS. 4-9 are merely for example and are not limiting. The plots in FIGS. 4-9 the load, in megawatts (MW), on the y-axis, and time, in minutes (min), on the x-axis. As shown, the gas turbine, prior to a time of zero minutes, is running at the current load set-point 48. At t=0 the new load set-point command is received, as described herein. The new set-point command can include the new load set-point 50, which in the FIGS. 4-11 is 80 MWs. FIGS. 4-9 include response time demands (e.g., ramp rate time) of 0.5 minutes, 2 minutes, 10 minutes and 20 minutes. In FIGS. 4-9, R1 corresponds to a ramp rate of a droop setting energy product type, R2 corresponds to a ramp rate of a regulation energy product type, R3 corresponds to a non-spinning reserve and spinning reserve energy product type, and R4 illustrates an economic energy product type. However, it should be understood that these ramp rates and ramp rate times are being used for example and are in no way limiting.

As shown in FIG. 4, the R1 is greater than R2, R3, and R4. T1 is the ramp rate time for R1, T2 is the ramp rate time for R2, T3 is the ramp rate time for R3, and T4 is the ramp rate time for R4. As discussed herein the systems and methods can determine if a ramp rate that does not produce temperature change rates and pressure changes that exceed the threshold temperature change rate and threshold pressure change. As seen in FIG. 4, the ramp rates R1-R1 include a single ramp rate. The ramp rates R1-R4 each reach the new load set-point within the ramp rates times (e.g., 0.5 minutes, 2 minutes, 10 minutes and 20 minutes). For example, the ramp rate time of 0.5 minutes corresponds to the droop setting energy product type, 2 minutes corresponds to the regulation energy product type, 10 minutes corresponds to a non-spinning or spinning reserve energy product type, and 20 minutes corresponds to an economic energy product type. Therefore, T1 is less than or equal to 0.5 minutes, T2 is less than or equal to 2 minutes, T3 is less than or equal to 10 minutes, and T4 is less than or equal to 20 minutes.

In FIG. 5, the ramp rates R1-R4 each reach the new load set-point within the ramp rate times; however, the ramp rates R1-R4 include two different ramp rates. The initial ramp rate Rm can be a minimum ramp rate that can prevent pressure fluctuations from exceeds the threshold pressure change. In FIG. 5, while all ramp rates R1-R4 include the minimum ramp rate Rm, in some examples only energy product types greater than, e.g., 0.5 minutes will include the minimum ramp rate.

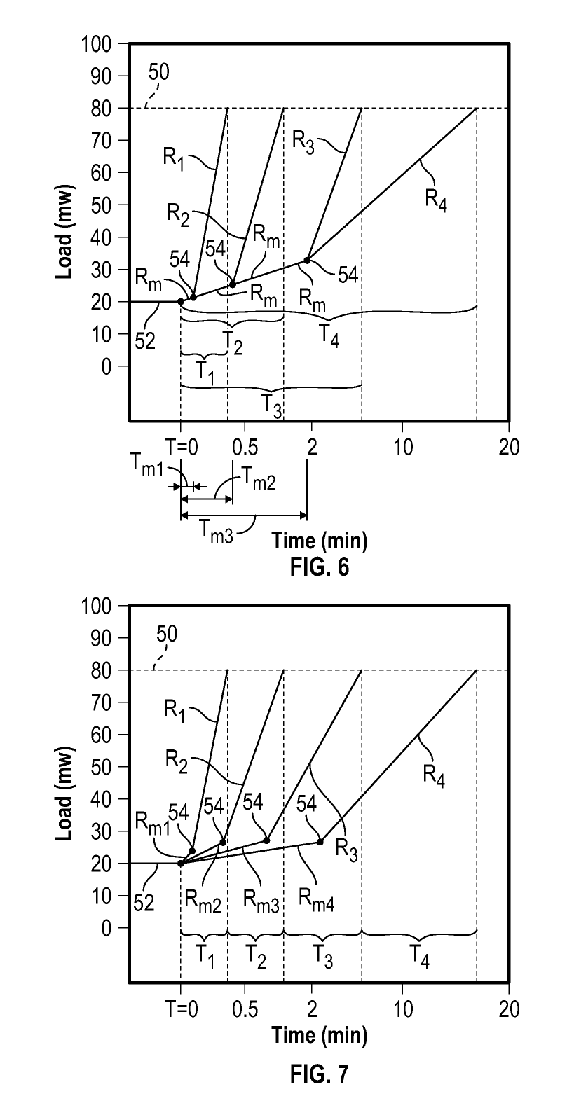

In FIG. 6 is similar to FIG. 5 except that the time that each ramp rate is at the minimum ramp rate Rm varies. For example, since the ramp rate time for an economic energy product type is larger than the ramp rate time for the droop energy type, the ramp rate for the droop energy type can operate at the minimum ramp rate Rm for a longer period of time, while still reaching the new load set-point within the ramp rate time.

In FIG. 7 is similar to FIG. 6 except that the minimum ramp rate Rm for each energy type varies. For example, since the ramp rate time for an economic energy product type is larger than the ramp rate time for the droop energy type, the minimum ramp rate Rm for the economic energy product type can be lower than the minimum ramp rate Rm for the droop energy product type. Similar to FIG. 6, the time spend operating at the minimum ramp rate can vary between each energy product type.

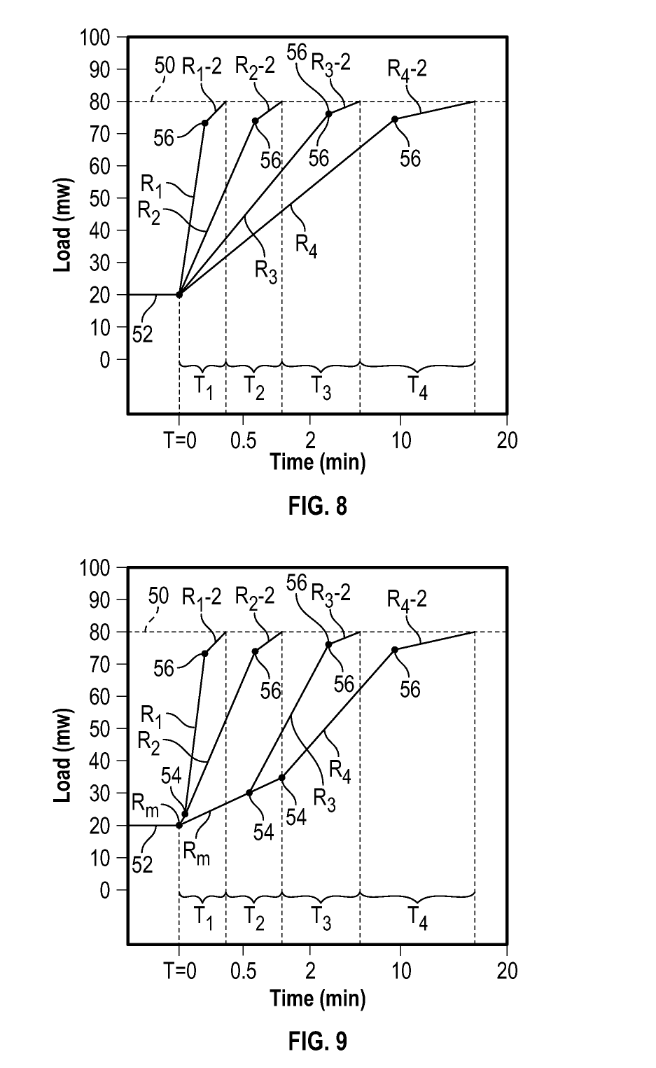

In FIG. 8, the ramp rates R1-R4 each reach the new load set-point within the ramp rate times; however, the ramp rates R1-R4 include two different ramp rates. The initial ramp rates can be the determined ramp rates R1-R4, but the second ramp rates R1-2, R2-2, R3-2, and R4-2 can be lower than the determined ramp rates R1-R4. The determined ramp rates R1-R4 can switch to the second ramp rates R1-2, R2-2, R3-2, and R4-2, for example, once the load within a predefined threshold of the new load set-point. In an example, the predefined threshold can vary between the determined energy product types. For example, since the ramp rate time for an economic energy product type is larger than the ramp rate time for the droop energy type, the ramp rate R4 can switch to R4-2 when the load is at a greater difference form the new load-set point as compared to when the ramp rate R1 switches to the second ramp rate R1-2. Additionally, the second ramp rates can also change based on the determined energy product. For example, the second ramp rate R4-2 for the economic energy product type can have a ramp rate less than the second ramp rate R1-2 for the droop energy product type.

In FIG. 9, each ramp profile includes three ramp rates. For example, an initial ramp rate such as the minimum ramp rate Rm, as discussed herein, the determined ramp rates R1-R4, and the second ramp rates R1-2, R1-2, R2-2, R3-2, and R4-R4-2, as discussed herein.

The various plots illustrated in FIGS. 4-9 illustrate various ramping profiles that can be determined by the ramp rate control unit 36. The plots include a determined ramp rate as discussed herein. Further, an initial ramp rate and/or a second ramp rate can be incorporated into the ramp profile to allow for the minimum rating rates to be used when a new load set-point is received. The methods and systems of the present disclosure can distinguish which new load set-points can use ramp profiles that include ramp rates that do not product temperature change rates or pressure changes that exceed the threshold temperature change rate and the threshold pressure change.

### Additional Notes

In the event of inconsistent usages between this document and any documents so incorporated by reference, the usage in this document controls. In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “substantially simultaneously” or “substantially immediately” or “substantially instantaneously” refers to events occurring at approximately the same time. It is contemplated by the inventor that response times can be limited by mechanical, electrical, or chemical processes and systems. Substantially simultaneously, substantially immediately, or substantially instantaneously can include time periods 1 minute or less, 45 seconds or less, 30 seconds or less, 20 seconds or less, 15 seconds or less, 10 seconds or less, 5 seconds or less, 3 seconds or less, 2 seconds or less, 1 second or less, 0.5 seconds or less, or 0.1 seconds or less.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 20 MW to about 25 MW” should be interpreted to include not just about 20 MW to about 25 MW but also the individual values (e.g., 21 MW, 22 MW, 23 MW, and 24 MW and the sub-ranges (e.g., 21.1 MW, 21.2 MW, 21.3 MW, and the like) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used herein can allow for a degree of variability in a value or range, for example, within 10%, within 5%, or within 1% of a stated value or of a stated limit of a range.

In the methods described herein, the steps can be carried out in any order without departing from the principles of the inventive subject matter, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for controlling a ramp rate of a gas turbine, comprising:
receiving, at a controller, a new load set-point command including a new load set-point;
determining an energy product corresponding to the new load set-point command;
determining a ramp rate time of the gas turbine associated with the determined energy product;
determining a ramp rate; and
ramping the gas turbine at the determined ramp rate such that new load set-point is reached within the determined ramp rate time.

2. The method of claim 1, further including receiving the new load set-point command from an operator in response to a new load set-point event.

3. The method of claim 1, further including receiving the new load set-point command from a gas turbine management system configured to detect a new load set-point event.

4. The method of claim 1, wherein a new load set-point event includes at least one of a gas turbine system transient, an energy facility transient, an environmental transient, and a grid system transient that fluctuates at least one of frequency, voltage, and power flow.

5. The method of claim 1, wherein the energy product is at least one of economic, non-spinning reserve, spinning reserve, regulation, and droop setting.

6. The method of claim 5, wherein an economic ramp rate time associated with the economic energy product is at least about 15 minutes.

7. The method of claim 5, wherein the non-spinning ramp rate time associated with the non-spinning reserve energy product and the spinning ramp rate time associated with the spinning reserve energy product is at least about 10 minutes.

8. The method of claim 5, wherein the regulation ramp rate time associated with the regulation energy product is at least about 2 minutes.

9. The method of claim 5, wherein the droop ramp rate time associated with the droop setting energy product is less than about 2 minutes.

10. The method of claim 5, wherein the droop setting energy product is associated with a new load set-point event.

11. The method of claim 1, wherein determining the ramp rate includes determining a slowest ramp rate capable of achieving the new load set-point according to the response time demand.

12. The method of claim 1, wherein determining the ramp rate includes determining a non-stalling ramp rate.

13. The method of claim 1, including increasing the determined ramp rate to prevent a gas turbine stall.

14. The method of claim 1, including varying the determined ramp rate during at least one of: as the gas turbine approaches the new load set-point and prior to ramping at the determined ramp rate.

15. A method for controlling a ramp rate of a gas turbine, comprising:
receiving, at a controller, a new load set-point command including a new load set-point;
determining an energy product corresponding to the new load set-point command, each energy product having a corresponding response time demand;
determining a ramp rate of the gas turbine associated with the determined energy product and response time demand; and
incrementally ramping the gas turbine to the new load set-point including at least a first ramp rate and the determined ramp rate, the determined ramp rate greater than the first ramp rate.

16. The method of claim 15, wherein ramping the gas turbine to the new load set-point includes maintaining a temperature change rate below a threshold temperature change rate, if the new load set-point can be reached within the response time demand.

17. The method of claim 15, wherein ramping the gas turbine to the new load set-point includes maintaining a pressure change below a threshold pressure change, if the new load set-point can be reached within the response time demand.

18. The method of claim 15, wherein the first ramp rate is a minimum ramp rate.

19. A system for controlling a ramp rate of a gas turbine, comprising:
a gas turbine engine;
a fuel adjuster configured to supply fuel to the gas turbine; and
a controller electrically coupled to the fuel valve and the gas turbine, the controller configured to receive a command including a new load set-point for the gas turbine, the controller, including:
a ramp rate control unit configured to:
determine an energy product corresponding to the new load set-point command;
determine a ramp rate of the gas turbine associated with the determined energy product; and
ramp the gas turbine at the determined ramp rate to the new load set-point.

20. The system of claim 19, wherein the ramp rate control unit is further configured to ramp the gas turbine to the new load set-point including at least a first ramp rate and the determined ramp rate, the determined ramp rate different from the first ramp rate.
